(19) United States
(12) Patent Application Publication
(10) Pub. No.: US 2017/0178457 A1
(43) Pub. Date: Jun. 22, 2017

(54) MULTI-PLAYER GAMING MACHINE

(71) Applicants: Jesus FRANCO MUNOZ, Madrid (ES); RECREATIVOS FRANCO, S.A., Madrid (ES)

(72) Inventor: Jesus FRANCO MUNOZ, Madrid (ES)

(21) Appl. No.: 15/324,447

(22) PCT Filed: Jul. 8, 2014
(86) PCT No.: PCT/ES2014/070557

§ 371 Date: Jan. 6, 2017

(51) Int. Cl. G07F 17/32

(52) U.S. Cl. CPC G07F 17/3288; G07F 17/3246; G07F 17/326; G07F 17/3272

(57) ABSTRACT

The present invention relates to a multiplayer gaming machine, that is made up of the conventional structure of a type “B” machine, the invention wherein the machine incorporates a server connected to wireless communication means, such that the machine itself is capable of offering users to download an application into their mobile telephones or the like, in which, once users are registered in the system, they can access the game cycle taking place in the main physical machine and play from their own mobile devices, such that several users can play the game simultaneously in one and the same game cycle.

### Object of the Invention

The present invention relates to a gaming machine of the type categorized as type “B” machine, in which there is established a minimum percentage of return, a maximum bet, a maximum prize, a single game cycle, and embodied in a “real” machine.

The object of the invention is to provide a gaming machine of this type with a new structure which generates greater user acceptance, as well as gains new users, i.e., attracting all kinds of public and not a specific kind of public, with a longer daily time of use, and which can compete with new technologies.

### BACKGROUND OF THE INVENTION

Although the aforementioned type “B” gaming machines, i.e., machines in the form of a physical device which is installed in a food service establishment, in which there is established a minimum percentage of return, a maximum bet, a maximum prize and a single game cycle, were widely accepted in such establishments, the truth is that new technologies and generations have caused the acceptance thereof to decrease considerably.

Specifically, such machines have been statistically proven to have increasingly more specific clientele which can be estimated at about 3% of users visiting such establishments.

Said machines have also been statistically proven to being used for a shorter time as well, in the order of one hour a day.

As a result, it would be desirable to have a gaming machine of this type which generates greater user acceptance, as well as gains new users, i.e., attracting all kinds of public and not a specific kind of public, with a longer daily time of use, and which can compete with new technologies.

### DESCRIPTION OF THE INVENTION

The gaming machine proposed by the invention solves in a fully satisfactory manner the drawbacks described above as a result of a highly effective novel structure, all this by maintaining the features required for such machines in order for them to be encompassed in category “B”.

To that end, the proposed machine being made up of the conventional structure of such machines, with the participation of a housing or main body of the machine, inside which there is established a display, control electronics, collection and payment means, a game interface, as well as, optionally, physical means corresponding to games which can be accessed when using the machine, the invention is characterized in that the control electronics is associated with a miniserver provided with wireless communication means, such as Wifi, Bluetooth or the like, from which users who are present in the proximity of the machine can download an application associated with said machine into their mobile telephones, tablets or laptops.

Specifically, the application will request users to register in the system, such that once registered, they can play on the machine physically and virtually from their own mobile telephones, tablets or the like, being able to choose if they want to collect the obtained winnings directly in their bank accounts or through the machine itself.

Obviously, the downloaded application is communicated through the wireless communication means of the device at all times with the server of the physical machine, so that the latter takes into account the moves made, the winnings obtained, etc, by each player.

In any case, as established by the rules, the game is based on one and the same winning cycle, such that when several players participate simultaneously through their mobile devices together with someone who participates physically from the machine itself, the machine will sum up all the moves made by all the players within one and the same cycle, thereby complying with the rules.

Finally, it must be highlighted that the downloaded application can offer, in addition to access to the game or games of said gaming machine, another type of games that are for fun so that the users are entertained, which considerably encourages downloading said software by another type of public that is not familiar with such machines, thereby increasing the social acceptance thereof.

Therefore, in addition to providing a machine which can be used by several players simultaneously, a device with greater social acceptance is offered, considerably increasing the user profiles thereof, all this with a longer time of use, due to the fact that several players can play at the same time at peak hours, that it competes with new technologies and that it allows payment in the same establishment in which it is played.

Optionally, it has been envisaged that, given that another person may be using the physical machine, a cash dispenser is established along therewith, likewise provided with communication means with the main machine, through which the users can access their winnings while another user is using the physical machine.

### DESCRIPTION OF THE DRAWINGS

To complement the description that will be made below and for the purpose of aiding to better understand the features of the invention according to a preferred practical embodiment thereof, a set of drawings is attached as an integral part of said description in which the following has been depicted with an illustrative and non-limiting character:

FIG. 1 shows a schematic block diagram of a multiplayer gaming machine made according to the object of the present invention.

FIG. 2 shows a view of the machine installed in a food service establishment, in which how the machine allows simultaneous participation of several players can be observed.

### PREFERRED EMBODIMENT OF THE INVENTION

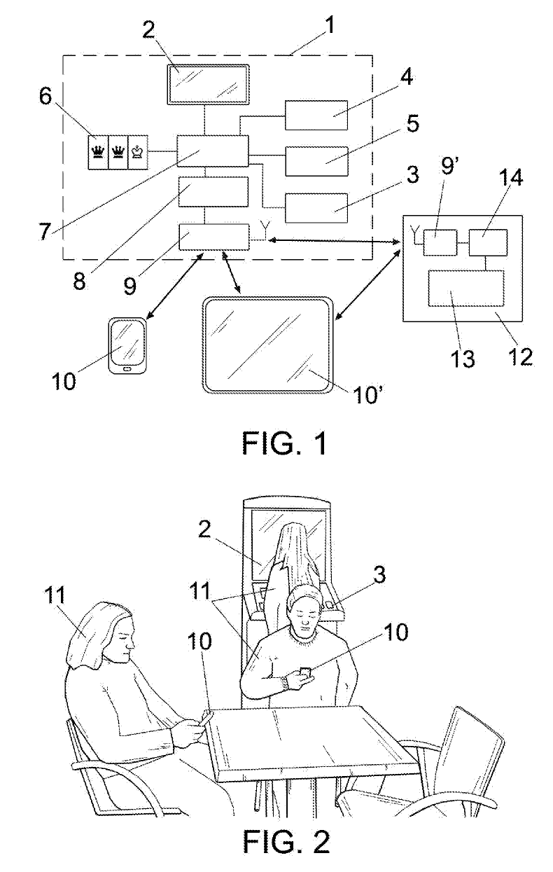

As can be seen in the mentioned drawings and particularly FIG. 1, the multiplayer gaming machine of the invention is made up of a conventional piece of furniture or housing (1), in which there is established a gaming display (2) with its corresponding control interface (3), conventional money insertion means (4) and payment means (5) for paying out the obtained winnings, being able to incorporate physical gaming mechanisms, such as rollers (6), drums or the like which participate in the games offered by such machines, all this controlled by a conventional microprocessor (7) and control electronics associated therewith.

According to the invention, it has been envisaged that a server (8) connected to wireless communication means (9), such as a Wifi communications module, Bluetooth communications module, or the like, is associated with said control electronics.

Based on this structure, it has been envisaged that by means of the mentioned wireless communication means (9), the machine itself is capable of offering users (11) to download an application into their mobile telephones (10), tablets (10′) or the like, in which, once the users (11) are registered in the system, they can access the game cycle taking place in the main physical machine, such that, as can be seen in FIG. 2, several users (11) can play the game simultaneously in one and the same game cycle.

Obviously, users (11) who choose to play through the application downloaded into their mobile telephones (10) or the like can collect the obtained winnings from the physical machine itself or the winnings can be deposited under their account numbers provided while registering in the system.

As mentioned previously, not only can the application allow accessing the game of the physical gaming machine in the actual game cycle thereof, rather it has been envisaged that the application allows accessing another type of games that are purely for fun, in order to broaden the profile or type of players thereof.

Finally, it must be highlighted that, given that the machine allows several players (11) to play at the same time, it has been envisaged that, to avoid having to wait for the person who is playing on the physical machine itself to finish playing, for collecting the winnings obtained by other players or users (11) who were able to access the game cycle through their mobile telephones (10), the physical machine can be complemented with a cash dispenser (12) provided with the corresponding payment means (13) associated with an internal microprocessor (14) and a wireless communication module (9′) whereby the users can be identified and communication can be made with said machine to proceed with the payment of the winnings.

1. A multiplayer gaming machine, being of the type categorized as type “B” machine, in which there is established a minimum percentage of return, a maximum bet, a maximum prize, a single game cycle, and embodied in a “virtual” machine, comprising a housing or main body of the machine, inside which there is established a display, control electronics, collection and payment means, a game interface, and optionally, physical means corresponding to games which can be accessed when using the machine, wherein the machine further incorporates a server connected to wireless communication means, through which the machine itself is capable of offering users to download an application into their mobile devices or the like, in which, once users are registered in the system, they can access through said application the game cycle taking place in the main physical machine and play from their own mobile devices or the like, such that several users can play the game simultaneously in one and the same game cycle.

2. The multiplayer gaming machine according to claim 1, wherein it is complemented with a cash dispenser provided with corresponding payment means associated with an internal microprocessor and a wireless communication module whereby the user can be identified and communication can be made with said machine.
